(19) United States
(12) Patent Application Publication
(10) Pub. No.: US 2017/0306503 A1
(43) Pub. Date: Oct. 26, 2017

(54) SYNTHETIC ACID COMPOSITIONS ALTERNATIVES TO CONVENTIONAL ACIDS IN THE OIL AND GAS INDUSTRY

(71) Applicant: FLUID ENERGY GROUP LTD, Calgary (CA)

(72) Inventors: Clay PURDY, Medicine Hat (CA); Darren THATCHER, High River (CA); Jon GARNER, Stony Plain (CA); Bruce ULMER, Stony Plain (CA)

(21) Appl. No.: 15/516,160

(22) PCT Filed: Sep. 29, 2015
(86) PCT No.: PCT/CA2015/000517

§ 371 Date: Mar. 31, 2017

(30) Foreign Application Priority Data
Oct. 2, 2014 (CA) 2,866,658

(51) Int. Cl. C23F 11/04; C09K 8/72; B08B 3/08; C09K 8/528; E21B 37/06; C23G 1/08

(52) U.S. Cl. CPC C23F 11/04; E21B 37/06; C23G 1/08; B08B 3/08; C09K 8/528; C09K 8/72

(57) ABSTRACT

A synthetic acid composition for use in oil industry activities, said composition comprising: urea and hydrogen chloride in a molar ratio of not less than 0.1:1; cinnamaldehyde or a derivative thereof; optionally, it may further comprise a phosphonic acid derivative; as well as a metal iodide or iodate; and an alcohol or derivative thereof.

### FIELD OF THE INVENTION

This invention relates to compositions for use in performing various applications in the oil & gas industry, more specifically to synthetic acid compositions as alternatives to conventional acids.

### BACKGROUND OF THE INVENTION

In the oil & gas industry, stimulation with an acid is performed on a well to increase or restore production. In some instances, a well initially exhibits low permeability, and stimulation is employed to commence production from the reservoir. In other instances, stimulation is used to further encourage permeability and flow from an already existing well that has become under-productive or to alleviate scaling due to water production on producing wells.

Acidizing is a type of stimulation treatment which is performed above or below the reservoir fracture pressure in an effort to restore or increase the natural permeability of the reservoir rock. Acidizing is achieved by pumping an acid or combination of such into the well to dissolve limestone, dolomite, calcite or combinations of various sedimentary deposits within the reservoir.

There are three major types of acid applications: matrix acidizing, fracture acidizing, and spearhead breakdown acidizing (pumped prior to a fracturing water based pad in order to assist with formation breakdown (reduce fracture pressures), or to clean up left over cement in the well bore or perforations, sleeves or other mechanically placed device. A matrix acid treatment is performed when acid is pumped into the well and into the pores of the reservoir rocks. In this form of acidization, the acids dissolve the sediments and mud solids that are inhibiting the permeability of the rock, enlarging the natural pores of the reservoir and stimulating flow of hydrocarbons. While matrix acidizing is done at a low enough pressure to keep from fracturing the reservoir rock, fracture acidizing involves pumping highly pressurized acid into the well, physically fracturing the reservoir rock as well as etching the pertheability inhibitive sediments. This type of acid treatment forms channels or fractures through which the hydrocarbons can flow typically referred to as wormholing.

There are many different mineral and organic acids used to perform an acid treatment on wells. The most common type of acid employed on wells to stimulate production is hydrochloric acid (HCI), which is useful in stimulating carbonate reservoirs,

Some of the major challenges faced in the oil & gas industry from using hydrochloric acid include the following: extremely high levels of corrosion (which is countered by the addition of ‘filming’ corrosion inhibitors that are typically themselves toxic and harmful to humans, the environment and equipment) reactions between acids and various types of metals can vary greatly but softer metals, such as aluminum, are very susceptible to major effects causing immediate damage and increasing product costs Hydrochloric acid produces Hydrogen chloride gas which is toxic and corrosive to skin, eyes and metals. At levels above 50 PPM (parts per million) it can be Immediately Dangerous to Life and Health (IDHL). At levels from 1300-2000 PPM death can occur in 2-3 minutes.

The inherent environmental effects (organic sterility, poisoning of wildlife etc.) of acids in the event of an unintended/accidental release on surface or downhole into water aquifers or sources of water are devastating which can cause significant pH reduction of such and can substantially increase the toxicity and could potentially cause a mass culling of aquatic species and potential poisoning of humans/livestock and wildlife exposed to/or drinking the water. An unintended release at surface can also cause a hydrogen chloride gas cloud to be released, potentially endangering human and animal health. This is a common event at large storage sites when tanks split or leak. Typically if near the public, large areas need to be evacuated post event. Because of its acidic nature, hydrogen chloride gas is also corrosive, particularly in the presence of moisture.

The inability for acids and blends of such to biodegrade naturally without neutralizing the soil results in expensive cleanup-reclamation costs for the operator should an unintended release occur. Moreover, the toxic fumes produced by mineral & organic acids are harmful to humans/animals and are highly corrosive and/or explosive potentially, transportation and storage requirements for acids are restrictive and taxing in such that you must typically haul the products in acid tankers or intermediate bulk containers (IBC) that are rated to handle such corrosive-regulated products, blending exposure dangers for personnel exposed to handling.

Another concern is the potential for spills on locations due to high corrosion levels of acids causing storage container failures and/or deployment equipment failures i.e. coiled tubing/tubing failures caused by high corrosion rates (pitting, cracks, major failures). Other concerns include: downhole equipment corrosion causing the operator to execute a work-over and replace down hole pumps, tubing, cables, packers etc.; inconsistent strength or quality level of mineral & organic acids; potential supply issues based on industrial output levels; high levels of corrosion on surface pumping equipment resulting in expensive repair and maintenance levels for operators and service companies; the requirement of specialized equipment that is purpose built to pump acids greatly increasing the capital expenditures of operators and service companies; and the inability to source a finished product locally or very near its end use.

Typically, acids are produced in industrial areas of countries located far from oil & gas applications, up to 10 additives can be required to control various aspects of the acids performance adding to complications in the handling and shipping logistics.

Large price fluctuations with typical mineral and organic acids based on industrial output causing end users an inability to establish long term costs in their respective budgets; severe reaction with dermal/eye tissue; major PPE requirements (personal protective equipment) for handling, such as on site shower units; extremely high corrosion rates and reaction rates as temperature increases causing the product to “spend/react or become neutral” prior to achieving its desired effect such as penetrating an oil or gas formation to increase the wormhole “pathway” effectively to allow the petroleum product to flow freely to the surface. As an example, hydrochloric acid or mud acid is utilized in an attempt to free stuck drill pipe in some situations. Prior to getting to the required depth to solubilize the formation that has caused the pipe/tubing to become stuck many acids spend or neutralize due to increased bottom hole temperatures and increased reaction rate, so it is advantageous to have an alternative that spends or reacts more methodically allowing the slough to be treated with a solution that is still active, allowing the pipe/tubing to be pulled free.

When used to treat scaling issues on surface due to water/fluid precipitation, acids are exposed to humans and mechanical devices as well as expensive pumping equipment causing increased risk for the operator and corrosion effects that damage equipment and create hazardous fumes. When mixed with bases or higher pH fluids, acids will create a large amount of thermal energy (exothermic reaction) causing potential safety concerns and equipment damage, acids typically need to be blended with fresh water to the desired concentration requiring companies to pre-blend off-site as opposed to blending on-site with water thereby increasing costs associated with transportation.

Typical mineral acids used in a pH control situation can cause degradation of certain polymers/additives/systems requiring further chemicals to be added to counter these potentially negative effects, many offshore areas of operations have very strict regulatory rules regarding the transportation/handling and deployment of acids causing increased liability and costs for the operator. When using an acid to pickle tubing or pipe, very careful attention must be paid to the process due to high levels of corrosion, as temperatures increase, the typical additives used to control corrosion levels in acid systems begin to degrade very quickly (due to the inhibitors “plating out” on the steel) causing the acids to become very corrosive and resulting in damage to equipment/wells. Acids are very destructive to most typical elastomers found in the oil & gas industry such as blow out preventers (BOP's)/downhole tools/packers/submersible pumps/seals etc. Having to deal with spent acid during the back flush process is also very expensive as acids typically are still a low pH and toxic. It is advantageous to have an acid blend that can be exported to production facilities through pipelines that once spent or applied, is commonly a neutral pH greatly reducing disposal costs/fees.

Acids perform many actions in the oil & gas industry and are considered necessary to achieve the desired production of various petroleum wells, maintain their respective systems and aid in certain functions (i.e. freeing stuck pipe). The associated dangers that come with using acids are expansive and tasking to mitigate through controls whether they are chemically or mechanically engineered

Eliminating or even simply reducing the negative effects of acids while maintaining their usefulness is a struggle for the industry. As the public demand for the use of cleaner/safer/greener products increases, companies are looking for alternatives that perform the required function without all or most of the drawbacks associated with the use of acids.

WO2001/027440 teaches an acidic fluid said to be useful in stimulation and workover operations, and in particular, in matrix acidizing treatments, comprises an acid, such as hydrochloric acid; water; an aliphatic aldehyde having 1-10 carbon atoms; and an aromatic aldehyde having 7-20 carbon atoms. The aliphatic aldehyde preferably has 1-6 carbon atoms. Glyoxylic acid and glyoxal are especially preferred aliphatic aldehydes. The aromatic aldehyde preferably has 7-10 carbon atoms. The description states that cinnamaldehyde is especially preferred.

U.S. Pat. No. 6,117,364 teaches an acid corrosion inhibitor composition for use in petroleum wells and water wells subjected to stimulation with acid solutions. The inhibitor combines cinnamaldehyde and an organo-sulfur compound. The inhibitor provides a reduced rate of corrosion and fewer instances of pitting than inhibitors which include cinnamaldehyde alone. The inhibitor does not suffer from the well-known oil field aldehyde/polyacrylamide crosslinking incompatibility. The enhanced performance by the inhibitor of the present invention is provided by a synergistic action between the cinnamaldehyde and an organo-sulfur compound.

U.S. Pat. No. 6,068,056 teaches an acidic fluid that is useful in stimulation and workover operations, and in particular, in matrix acidizing treatments, comprises an acid, such as hydrochloric acid; water; an aliphatic aldehyde having 1-10 carbon atoms; and an aromatic aldehyde having 7-20 carbon atoms. The aliphatic aldehyde preferably has 1-6 carbon atoms. Glyoxylic acid and glyoxal are especially preferred aliphatic aldehydes. The aromatic aldehyde preferably has 7-10 carbon atoms. The composition is said to effectively dissolve FeS without significantly releasing H2S.

WO 2010/119235 teaches methods and compositions that include a method comprising contacting a metal surface with an acidic fluid comprising a corrosion inhibitor that comprises a reaction product formed from a direct or an indirect reaction of an aldehyde with a thiol and/or an amine functionalized ring structure. A composition provided includes an acidic treatment fluid that comprises an aqueous-base fluid, and acid, and a corrosion inhibitor that comprises a reaction product formed from a direct or an indirect reaction of an aldehyde with a thiol and/or an amine functionalized ring structure.

WO2008/110789 teaches corrosion-inhibiting additives comprising certain surfactants, and associated treatment fluids and methods of use are described. In one embodiment, the method comprises: providing a treatment fluid that comprises a base fluid, an ss-unsaturated aldehyde, a sulfur-containing compound, and at least one nitrogen-containing surfactant that is anionic, nonionic, amphoteric, or zwitterionic; and introducing the treatment fluid into a subterranean formation. In another embodiment, the method comprises: providing a corrosion-inhibiting additive that comprises an unsaturated aldehyde, a sulfur-containing compound, and at least one nitrogen-containing surfactant that is anionic, nonionic, amphoteric, or zwitterionic; contacting a surface with the corrosion-inhibiting additive; and allowing the corrosion-inhibiting additive to interact with the surface, whereby corrosion of the surface is at least partially inhibited or a portion of an undesirable substance on the surface is removed.

WO2005/075707 teaches methods of inhibiting corrosion comprising the step of providing a corrosive environment; adding a corrosion inhibitor comprising a reaction product of a thiol compound and an aldehyde compound. Methods of acidizing a near well bore region of a subterranean formation comprising the steps of isolating a zone of interest along a well bore; and placing an acidizing solution the zone of interest wherein the acidizing solution comprises an acid and a corrosion inhibiting compound comprising the reaction product of a thiol compound and an aldehyde compound.

EP 2 471 887 teaches corrosion-inhibiting additives comprising certain surfactants, and associated treatment fluids and methods of use are described. In one embodiment, the method comprises: providing a treatment fluid that comprises a base fluid, an +−,-unsaturated aldehyde, a sulfur-containing compound, and at least one nitrogen-containing surfactant that is anionic, nonionic, amphoteric, or zwitterionic; and introducing the treatment fluid into a subterranean formation. In another embodiment, the method comprises: providing a corrosion-inhibiting additive that comprises an +−,-unsaturated aldehyde, a sulfur-containing compound, and at least one nitrogen-containing surfactant that is anionic, nonionic, amphoteric, or zwitterionic; contacting a surface with the corrosion-inhibiting additive; and allowing the corrosion-inhibiting additive to interact with the surface, whereby corrosion of the surface is at least partially inhibited or a portion of an undesirable substance on the surface is removed.

U.S. Pat. No. 5,854,180 teaches the inhibition of corrosion is inhibited acid solutions used to acidize wells. The inhibition is done by adding to the solutions a corrosion inhibiting composition comprising cinnamaldehyde or a substituted cinnamaldehyde together with a reaction product of a C3-6 ketone such as acetophenone, thiourea or a related compound, formaldehyde and hydrochloric acid. The composition and method for inhibiting the corrosion contains no quaternary amines, no acetylenic alcohol, no formaldehyde, and no phenol ethoxylate surfactants, all of which are common ingredients in prior art acidizing corrosion inhibitors.

Despite these compositions, there is still a need for compositions for use in the oil industry which can be used over a wide range of applications which can decrease a number of the associated dangers/issues typically associated with acid applications to the extent that these acid compositions are considered much safer for handling on worksites and decrease the costs associated with typical alternatives.

### SUMMARY OF THE INVENTION

Compositions according to the present invention have been developed for the oil & gas industry and its associated applications, by targeting the problems of corrosion, logistics/handling, human/environmental exposure and formation/fluid compatibilities as well as costs.

It is an object of the present invention to provide a synthetic acid composition which can be used over a broad range of applications in the oil and gas industry and which exhibit advantageous properties over known compositions.

According to one aspect of the present invention, there is provided a synthetic acid composition which, upon proper use, results in a very low corrosion rate of oil and gas industry tubulars/equipment.

According to another aspect of the present invention, there is provided a synthetic acid composition for use in the oil industry which is biodegradable.

According to a preferred embodiment of the present invention, there is provided a synthetic acid composition for use in the oil industry which has a methodically spending (reacting) nature that is linear as temperature increases, non-fuming, non-toxic, and has a highly controlled manufacturing process providing for a consistent end product

According to a preferred embodiment of the present invention, there is provided a synthetic acid composition for use in the oil industry which has a pH below 1.

According to a preferred embodiment of the present invention, there is provided a synthetic acid composition for use in the oil industry which has minimal exothermic reactivity.

According to a preferred embodiment of the present invention, there is provided a synthetic acid composition for use in the oil industry which is compatible with most existing industry additives.

According to a preferred embodiment of the present invention, there is provided a synthetic acid composition for use in the oil industry which has higher salinity tolerance. A tolerance for high salinity fluids, or brines, is desirable for onshore and offshore acid applications. Conventional acids are normally blended with fresh water and additives, typically far offsite, and then transported to the area of treatment as a finished blend. It is advantageous to have an alternative that can be transported as a concentrate safely to the treatment area, then blended with a saline produced water or sea water greatly reducing the logistics requirement. A conventional acid system will precipitate salts/minerals heavily if blended with fluids of an excessive saline level resulting in formation plugging or ancillary damage inhibiting production and substantially increasing costs. Brines are also typically present in formations, thus having an acid system that has a high tolerance for brines greatly reduces the potential for formation damage or emulsions forming down-hole during or after product placement/spending occurs.

According to another aspect of the present invention, there is provided a synthetic acid composition for use in the oil industry which is immediately reactive upon contact/application.

According to another aspect of the present invention, there is provided a synthetic acid composition for use in the oil industry which results in less unintended near wellbore erosion due to the controlled reaction rate. This, in turn, results in deeper formation penetration, increased permeability, and reduces the potential for zonal communication during a typical ‘open hole’ mechanical isolation application treatment. As a highly reactive acid, such as hydrochloric acid, is deployed into a well that has open hole packers for isolation (without casing) there is a potential to cause a loss of near-wellbore compressive strength resulting in communication between zones or sections of interest as well as potential sand production, and fines migration. It is advantageous to have an alternative that will react with a much more controlled rate or speed, thus greatly reducing the potential for zonal communication and the above potential negative side effects of traditional acid systems.

According to another aspect of the present invention, there is provided a synthetic acid composition for use in the oil industry which provides a controlled and comprehensive reaction throughout a broad range of temperatures.

Accordingly, the product would overcome many of the drawbacks found in the use of compositions of the prior art related to the oil & gas industry.

### DETAILED DESCRIPTION OF THE PREFERRED EMBODIMENTS

The description that follows, and the embodiments described therein, are provided by way of illustration of an example, or examples, of particular embodiments of the principles of the present invention. These examples are provided for the purposes of explanation, and not limitation, of those principles and of the present invention.

According to an aspect of the invention, there is provided a synthetic acid composition comprising:
urea & hydrogen chloride in a molar ratio of not less than 0.1:1; preferably in a molar ratio not less than 0.5:1, more preferably in a molar ratio not less than 1.0:1; and
cinnamaldehyde or a derivative amine thereof.

Cinnamaldehyde or a derivative amine thereof can be present in an amount ranging from 0.01-1.0%, preferably in an amount of approximately 0.03%; cinnamaldehyde is the preferred compound.

According to a preferred embodiment of the present invention, the composition further comprises a metal iodide or iodate. More preferably, the iodide is selected form the group consisting of: cupric iodide, potassium iodide, lithium iodide and sodium iodide.

According to a preferred embodiment of the present invention, the composition further comprises a phosphonic acid or derivatives, preferably alkylphosphonic acid or derivatives thereof and more preferably amino tris methylene phosphonic acid and derivatives thereof.

According to a preferred embodiment of the present invention, the composition further comprises an alcohol or derivatives thereof, preferably alkynyl alcohol or derivatives thereof, more preferably propargyl alcohol (or a derivative of).

Urea is the main component in terms of volume and weight percent of the composition of the present invention, and consists basically of a carbonyl group connecting with nitrogen and hydrogen. When added to hydrochloric acid, there is a reaction that results in urea hydrochloride, which basically traps the chloride ion within the molecular structure. This reaction greatly reduces the hazardous effects of the hydrochloric acid on its own, such as the fuming effects, the hygroscopic effects, and the highly corrosive nature (the Cl⁻ ion will not readily bond with the Fe ion). The excess nitrogen can also act as a corrosion inhibitor at higher temperatures. Urea & Hydrogen Chloride in a molar ratio of not less than 0.1:1; preferably in a molar ratio not less than 0.5:1, and more preferably in a molar ratio not less than 1.0:1. However, this ratio can be increased depending on the application.

It is preferable to add the urea at a molar ratio greater than 1 to the moles of HCl acid (or any acid). This is done in order to bind any available Cl⁻ ions, thereby creating a safer, more inhibited product. Preferably, the composition according to the present invention comprises 1.05 moles of urea per 1.0 moles of HCl. The urea (hydrochloride) also allows for a reduced rate of reaction when in the presence of carbonate-based materials. This again due to the stronger molecular bonds associated over what hydrochloric acid traditionally displays. Further, since the composition according to the present invention is mainly comprised of urea (which is naturally biodegradable), the product testing has shown that the urea hydrochloride will maintain a similar biodegradability function, something that hydrochloric acid will not.

Phosphonic acids and derivatives such as amino tris methylene phosphonic acid (ATMP) have some value as scale inhibitors. In fact, ATMP is a chemical traditionally used as an oilfield scale inhibitor, it has been found, when used in combination with urea/HCl, to increase the corrosion inhibition. It has a good environmental profile, is readily available and reasonably priced.

Amino tris (methylenephosphonic acid) (ATMP) and its sodium salts are typically used in water treatment operations as scale inhibitors. They also find use as detergents and in cleaning applications, in paper, textile and photographic industries and in off-shore oil applications. Pure ATMP presents itself as a solid but it is generally obtained through process steps leading to a solution ranging from being colourless to having a pale yellow colour. ATMP acid and some of its sodium salts may cause corrosion to metals and may cause serious eye irritation to a varying degree dependent upon the pH/degree of neutralization.

ATMP must be handled with care when in its pure form or not in combination with certain other products. Typically, ATMP present in products intended for industrial use must be maintained in appropriate conditions in order to limit the exposure at a safe level to ensure human health and environment.

Amino tris (methylenephosphonic acid) and its sodium salts belong to the ATMP category in that all category members are various ionized forms of the acid. This category includes potassium and ammonium salts of that acid. The properties of the members of a category are usually consistent. Moreover, certain properties for a salt, in ecotoxicity studies, for example, can be directly appreciated by analogy to the properties of the parent acid. Amino tris (methylenephosphonic acid) may specifically be used as an intermediate for producing the phosphonates salts. The salt is used in situ (usually the case) or stored separately for further neutralization. One of the common uses of phosphonates is as scale inhibitors in the treatment of cooling and boiler water systems. In particular, for ATMP and its sodium salts are used in to prevent the formation of calcium carbonate scale.

Alcohols and derivatives thereof, such as alkyne alcohols and derivatives and preferably propargyl alcohol and derivatives thereof can be used as corrosion inhibitors. Propargyl alcohol itself is traditionally used as a corrosion inhibitor which works extremely well at low concentrations. It is a toxic/flammable chemical to handle as a concentrate, so care must be taken during handling the concentrate. In the composition according to the present invention, the toxic effect does not negatively impact the safety of the composition.

Metal iodides or iodates such as potassium iodide, sodium iodide and cuprous iodide can potentially be used as corrosion inhibitor intensifier. In fact, potassium iodide is a metal iodide traditionally used as corrosion inhibitor intensifier, however it is expensive, but works well. It is non-regulated and friendly to handle.

As a substitute for cinnamaldehyde one could use cinnamaldehyde derivatives selected from the group consisting of: dicinnamaldehyde p-hydroxycinnamaldehyde; p-methylcinnamaldehyde; p-ethylcinnamaldehyde; p-methoxycinnamaldehyde; p-dimethylaminocinnamaldehyde; p-diethylaminocinnamaldehyde; p-nitrocinnamaldehyde; o-nitrocinnamaldehyde; 4-(3-propenal)cinnamaldehyde; p-sodium sulfocinnamaldehyde p-trimethylammoniumcinnamaldehyde sulfate; p-trimethylammoniumcinnamaldehyde o-methylsulfate; p-thiocyanocinnamaldehyde; p-(S-acetyl)thiocinnamaldehyde; p-(S-N,N-dimethylcarbamoylthio)cinnamaldehyde; p-chlorocinnamaldehyde; α-methylcinnamaldehyde; β-methylcinnamaldehyde; α-chlorocinnamaldehyde α-bromocinnamaldehyde; α-butylcinnamaldehyde; α-amylcinnamaldehyde; α-hexylcinnamaldehyde; α-bromo-p-cyanocinnamaldehyde; α-ethyl-p-methylcinnamaldehyde and p-methyl-α-pentylcinnamaldehyde. The most preferred is cinnamaldehyde.

### EXAMPLE 1

### Process to Prepare a Composition According to a Preferred Embodiment of the Invention

Start with a 50% by weight solution of pure urea liquor. Add a 36% by weight solution of hydrogen chloride while circulating until all reactions have completely ceased. The cinnamaldehyde is then added. Circulation is maintained until all products have been solubilized.

Table 1 lists the components of the composition of Example 1 including their weight percentage as compared to the total weight of the composition and the CAS numbers of each component.

TABLE 1
Composition of a preferred embodiment of the present invention

| Chemical | % Wt Composition | CAS# |
|---|---|---|
| Water | 60.90% | 7732-18-5 |
| Urea Hydrochloride | 39.0% | 506-89-8 |
| Cinnamaldehyde | 0.1% | 14371-10-9 |

The resulting composition of Example 1 is a clear, odourless liquid having shelf-life of greater than 1 year. It has a freezing point temperature of approximately minus 30° C. and a boiling point temperature of approximately 100° C. It has a specific gravity of 1.15±0.02. It is completely soluble in water and its pH is less than 1.

The composition is biodegradable (with Nitrification allowance) and is classified as a nonirritant according to the classifications for skin classification. The composition is non-fuming and has no volatile organic compounds nor does it have any BTEX levels above the drinking water quality levels. BTEX refers to the chemicals benzene, toluene, ethylbenzene and xylene. Toxicity testing, as calculated, has an LD50 greater than 2000 mg/kg.

Corrosion Testing

The composition according to the present invention of Example 1 was exposed to corrosion testing. The results of the corrosion tests are reported in Table 2.

Samples of J55 grade steel were exposed to various synthetic acid solutions for periods of time ranging up to 24 hours at 90° C. temperatures. All of the tested compositions contained HCl and urea in a 1:1.05 ratio

TABLE 2
Corrosion testing comparison between HCl-Urea and the composition of
Example 1 of the present invention

| | | | Loss | Surface | | Run | | | |
|---|---|---|---|---|---|---|---|---|---|
| | Initial | Final | wt. | area | Density | time | | | |
| Inhibitor (%) | wt. (g) | wt. (g) | (g) | (cm2) | (g/cc) | (hours) | Mils/yr | Mm/year | Lb/ft2 |
| HCl-Urea | 37.616 | 34.524 | 3.092 | 28.922 | 7.86 | 6 | 7818.20 | 198.582 | 0.222 |
| HCl-Urea | 37.616 | 31.066 | 6.550 | 28.922 | 7.86 | 24 | 4140.46 | 105.168 | 0.470 |
| HCl-Urea + | 38.181 | 35.556 | 2.625 | 28.922 | 7.86 | 6 | 6637.38 | 168.589 | 0.189 |
| cinnamaldehyde | | | | | | | | | |
| @ 0.1% | | | | | | | | | |
| HCl-Urea + | 38.181 | 33.027 | 5.154 | 28.922 | 7.86 | 24 | 3258.01 | 82.753 | 0.370 |
| cinnamaldehyde | | | | | | | | | |
| @ 0.1% | | | | | | | | | |

With respect to the corrosion impact of the composition on typical oilfield grade steel, it was established that it enhances the corrosion resistance compared to the HCl-urea composition alone.

This type of corrosion testing helps to determine the impact of the use of such synthetic replacement acid composition according to the present invention compared to the industry standard (HCl blends or any other mineral or organic acid blends). The results obtained for the composition containing only HCl and urea were used as a baseline to compare the other compositions. Additionally, the compositions according to the present invention will allow the end user to utilize an alternative to conventional acids that has the down-hole performance advantages, transportation and storage advantages as well as the health, safety and environmental advantages. Enhancement in short/long term corrosion control is one of the key advantages of the present invention. The reduction in skin corrosiveness, the controlled spending nature, and the high salt tolerance are some other advantages of compositions according to the present invention.

The compositions according to the present invention can be used directly (ready-to-use) or be diluted with water depending on their use. Most preferably blended with water to further decrease corrosion, reduce costs, and increase HSE advantages.

The uses (or applications) of the compositions according to the present invention upon dilution thereof ranging from approximately 1 to 75% dilution, include, but are not limited to: injection/disposal in wells; squeezes and soaks or bullheads; acid fracturing, acid washes or matrix stimulations; fracturing spearheads (breakdowns); pipeline scale treatments, cement breakdowns or perforation cleaning; pH control; and de-scaling applications.

While the foregoing invention has been described in some detail for purposes of clarity and understanding, it will be appreciated by those skilled in the relevant arts, once they have been made familiar with this disclosure that various changes in form and detail can be made without departing from the true scope of the invention in the appended claims.

1.-36. (canceled)

37. A synthetic acid composition for use in oil industry activities, said composition comprising:
urea and hydrogen chloride in a molar ratio of not less than 0.1:1; and
cinnamaldehyde or a derivative amine thereof.

38. The synthetic acid composition according to claim 37, wherein the urea and hydrogen chloride are in a molar ratio of not less than 0.5:1.

39. The synthetic acid composition according to claim 37, wherein the urea and hydrogen chloride are in a molar ratio of not less than 0.8:1.

40. The synthetic acid composition according to claim 37, wherein the urea and hydrogen chloride are in a molar ratio of not less than 1.0:1.

41. The synthetic acid composition according to claim 37, wherein the composition further comprises a metal iodide or iodate.

42. The synthetic acid composition according to claim 37, further comprising a metal iodide or iodate selected from the group consisting of: is cuprous iodide, potassium iodide, and sodium iodide.

43. The synthetic acid composition according to claim 37, wherein the composition further comprises an alcohol or derivative thereof.

44. The synthetic acid composition according to claim 37, wherein the composition further comprises an alkynyl alcohol or derivative thereof.

45. The synthetic acid composition according to claim 37, wherein the composition further comprises propargyl alcohol or a derivative thereof.

46. The synthetic acid composition according to claim 37, wherein the composition further comprises an alkynyl alcohol or derivative thereof present in a concentration ranging from 0.01 to 0.25% w/w.

47. The synthetic acid composition according to claim 37, wherein the composition further comprises an alkynyl alcohol or derivative thereof present in a concentration of 0.1% w/w.

48. The synthetic acid composition according to claim 37, wherein the composition further comprises a metal iodide or iodate present in a concentration ranging from 100 to 1000 ppm.

49. The synthetic acid composition according to claim 37, where cinnamaldehyde amine derivatives is selected from the group consisting of: dicinnamaldehyde p-hydroxycinnamaldehyde; p-methylcinnamaldehyde; p-ethylcinnamaldehyde; p-methoxycinnamaldehyde; p-dimethylaminocinnamaldehyde; p-diethylaminocinnamaldehyde; p-nitrocinnamaldehyde; o-nitrocinnamaldehyde; 4-(3-propenal)cinnamaldehyde; p-sodium sulfocinnamaldehyde p-trimethylammoniumcinnamaldehyde sulfate; p-trimethylammoniumcinnamaldehyde o-methylsulfate; p-thiocyanocinnamaldehyde; p-(S-acetyl)thiocinnamaldehyde; p-(S-N,N-dimethylcarbamoylthio)cinnamaldehyde; p-chlorocinnamaldehyde; a-methylcinnamaldehyde; β-methylcinnamaldehyde; a-chlorocinnamaldehyde a-bromocinnamaldehyde; a-butylcinnamaldehyde; a-amylcinnamaldehyde; a-hexylcinnamaldehyde; a-bromo-p-cyanocinnamaldehyde; a-ethyl-p-methylcinnamaldehyde and p-methyl-a-pentylcinnamaldehyde.

50. The synthetic acid composition according to claim 37, wherein the cinnamaldehyde or a derivative amine thereof is present in a concentration ranging from 0.01 to 1.0% w/w.

51. The synthetic acid composition according to claim 37, wherein the cinnamaldehyde or a derivative amine thereof is present in a concentration of 0.1% w/w.

52. The use of a synthetic acid composition in oil industry activities, said composition comprising:
urea and hydrogen chloride in a molar ratio of not less than 0.1:1; and
cinnamaldehyde or a derivative amine thereof;
wherein the use comprises an activity selected from the group consisting of: stimulate formations; assist in reducing breakdown pressures during downhole pumping operations; treat wellbore filter cake post drilling operations; assist in freeing stuck pipe; descale pipelines and/or production wells; increase injectivity of injection wells; lower the pH of a fluid; remove undesirable scale on a surface selected from the group consisting of: equipment, wells and related equipment and facilities; fracture wells; complete matrix stimulations; conduct annular and bullhead squeezes & soaks; pickle tubing, pipe and/or coiled tubing; increase effective permeability of formations; reduce or remove wellbore damage; clean perforations; and solubilize limestone, dolomite, calcite and combinations thereof.
